(19) United States
(12) Patent Application Publication
(10) Pub. No.: US 2023/0376687 A1
(43) Pub. Date: Nov. 23, 2023

(54) MULTIMODAL EXTRACTION ACROSS MULTIPLE GRANULARITIES

(71) Applicant: ADOBE INC., SAN JOSE, CA (US)

(72) Inventors: Vlad Ion Morariu, Potomac, MD (US); Tong Sun, San Ramon, CA (US); Nikolaos Barmpalios, Palo Alto, CA (US); Zilong Wang, La Jolla, CA (US); Jiuxiang Gu, Baltimore, MD (US); Ani Nenkova Nenkova, Philadelphia, PA (US); Christopher Tensmeyer, Columbia, MD (US)

(21) Appl. No.: 17/746,779

(22) Filed: May 17, 2022

(51) Int. Cl. G06F 40/279; G06N 5/02

(52) U.S. Cl. CPC G06F 40/279; G06N 5/022

(57) ABSTRACT

Embodiments are provided for facilitating multimodal extraction across multiple granularities. In one implementation, a set of features of a document for a plurality of granularities of the document is obtained. Via a machine learning model, the set of features of the document are modified to generate a set of modified features using a set of self-attention values to determine relationships within a first type of feature and a set of cross-attention values to determine relationships between the first type of feature and a second type of feature. Thereafter, the set of modified features are provided to a second machine learning model to perform a classification task.

### BACKGROUND

Documents formatted in a portable document format (PDF) are used to simplify the display and printing of structured documents. These PDF documents permit incorporation of a text and graphics in a manner that provides consistency in the display of documents across heterogeneous computing environments. In addition, it is often necessary to extract text and/or other information from a document encoded as a PDF to perform various operations. For example, text and location information can be extracted to determine an entity associated with the document. To optimize such tasks, existing tools (e.g., natural language models) focus on a single region of the document, which ignores inter-region information and provides sub-optimal results when extracting information from other regions. In addition, multiple models may be required to extract information from multiple regions, leading to increased cost and maintenance.

### SUMMARY

Embodiments described herein are directed to determining information from a PDF document based at least in part on relationships and other data extracted from a plurality of granularities of the PDF document. As such, the present technology is directed towards generating and using a multi-modal multi-granular model to analyze various document regions of different granularities or sizes. To accomplish the multi-granular aspect, the machine learning model analyzes components of a document at different granularities (e.g., page, region, token, etc.) by generating an input to the model that includes features extracted from the different granularities. For example, the input to the multi-modal multi-granular model includes a fixed length feature vector including features and bounding box information extracted from a page-level, region-level, and token-level of the document. With regard to the multi-modal aspect, a machine learning model analyzes different types of features (e.g., textual, visual features, and/or other features) associated with the document. As one example, the machine learning model analyzes visual features obtained from a convolutional neural network (CNN) and textual features obtained using optical character recognition (OCR), transforming such features first based on self-attention weights (e.g., within a single modality or type of feature) and then based on cross-attention weights (e.g., between modalities or types of features). These transformed feature vectors can then be provided to other machine learning models to perform various tasks (e.g., document classification, entity recognition, token recognition, etc.).

The multi-modal multi-granular model provides a single machine learning model that provides optimal results used for performing subsequent tasks, thereby reducing training and maintenance costs required for the machine learning models to perform these subsequent tasks. For example, the multi-modal multi-granular model is used with a plurality of different classifiers thereby reducing the need to train and maintain separate models. Furthermore, the multi-modal multi-granular model is also capable of detecting and/or obtaining context information or other information across regions and/or levels of the document. For example, based at least in part on the multi-modal multi-granular model processing inputs at multiple levels and/or regions of the document, the multi-modal multi-granular model determines a parent-child relationship between distinct regions of the document.

### BRIEF DESCRIPTION OF THE DRAWINGS

FIG. 1 depicts a diagram of an environment in which one or more embodiments of the present disclosure can be practiced.

FIG. 2 is a diagram of a multi-modal multi-granular tool, in accordance with at least one embodiment.

FIG. 3 is a diagram of an environment in which a multi-modal multi-granular model is used to perform one or more task, in accordance with at least one embodiment.

FIG. 4A is a diagram of an environment in which a multi-modal multi-granular model is used to perform one or more task, in accordance with at least one embodiment.

FIG. 4B is a diagram of an environment in which a multi-modal multi-granular model is used to perform one or more task, in accordance with at least one embodiment.

FIG. 5 is a diagram of an environment in which input for a multi-modal multi-granular model is generated, in accordance with at least one embodiment.

FIG. 6 is a diagram of an environment in which various terms of a multi-modal multi-granular model are generated, in accordance with at least one embodiment.

FIG. 7 is a diagram of an environment in which various terms of a multi-modal multi-granular model are generated, in accordance with at least one embodiment.

FIG. 8 is a diagram of an environment in which a multi-modal multi-granular model is used to perform a plurality of tasks, in accordance with at least one embodiment.

FIG. 9 an example process flow for using a multi-modal multi-granular tool to perform one or more task, in accordance with at least one embodiment.

FIG. 10 an example process flow for training a multi-modal multi-granular model to perform one or more task, in accordance with at least one embodiment.

FIG. 11 is a block diagram of an example computing device in which embodiments of the present disclosure may be employed.

### DETAILED DESCRIPTION

It is generally inefficient and inaccurate to have a single machine learning model to extract or otherwise determine information from a document. In many cases, these models are trained using only a single level or granularity (e.g., page, region, token) of a document and therefore are inefficient and inaccurate when determining information at a granularity other than the granularity at which the model was trained. In some examples, an entity recognition model is trained on data extracted from a region granularity of a document and is inefficient and inaccurate when extracting information from a page granularity or token granularity and, therefore, provides suboptimal results when information is included at other granularities. In addition, these conventional models are trained and operated in a single modality. In various examples, a model trained on tokens that comprises characters and words (e.g., a first modality) is ineffective at extracting information from images (e.g., a second modality).

Furthermore, training these conventional models based on a single granularity prevents the models from determining or otherwise extracting information between and/or relating different granularities. For example, conventional models are unable to determine relationships between granularities such as parent-child relationships, relationships between elements of a form, relationship between lists of elements, and other relationships within granularities and/or across granularities. Based on these deficiencies, it may be difficult to extract certain types of information from documents. In addition, conventional approaches may require the creation, training, maintenance, and upkeep of a plurality of models to perform various tasks. Creation, training, maintenance, and upkeep of multiple models consumes a significant amount of computing resources.

Accordingly, embodiments of the present technology are directed towards generating and using a multi-modal multi-granular model to analyze document regions of multiple sizes (e.g., granularities) and generate data (e.g., feature vectors) suitable for use in performing multiple tasks. For example, the multi-modal multi-granular model can be used in connection with one or more other machine learning models to perform various tasks such as the page-level document extraction, region-level entity recognition, and/or token-level token classification. The multi-modal multi-granular model takes as an input features extracted from a plurality of regions and/or granularities of the document—such as document, page, region, paragraph, sentence, and word granularities—and outputs transform features that can be used, for example, by a classifier or other machine learning model to perform a task. In an example, the input includes textual features (e.g., tokens, letters, numbers, words, etc.), image features, and bounding boxes representing regions and/or tokens from a document (e.g., page, paragraph, character, word, feature, image, etc.).

In this regard, an input generator of the multi-modal multi-granular tool, for example, generates a semantic feature vector and a visual feature vector which are in turn used as inputs to a uni-modal encoder (e.g., of the multi-modal multi-granular model) which transforms the semantic feature vector and the visual feature vector, as described in greater detail below, the transformed semantic feature vector and visual feature vector are provided as an input to a cross-modal encoder of the multi-modal multi-granular model to generate attention weights (e.g., self-attention and cross-attention) associated with the semantic features and visual features. In various examples, the information generated by the multi-modal multi-granular model (e.g., the feature vectors including the attention weights) can be provided to various classifiers to perform various tasks (e.g., such as document classification, entity recognition, token recognition, etc.). As described above, conventional technologies typically focus on a single region of the document, thereby providing sub-optimal results when extracting information from another region and/or determining information across regions.

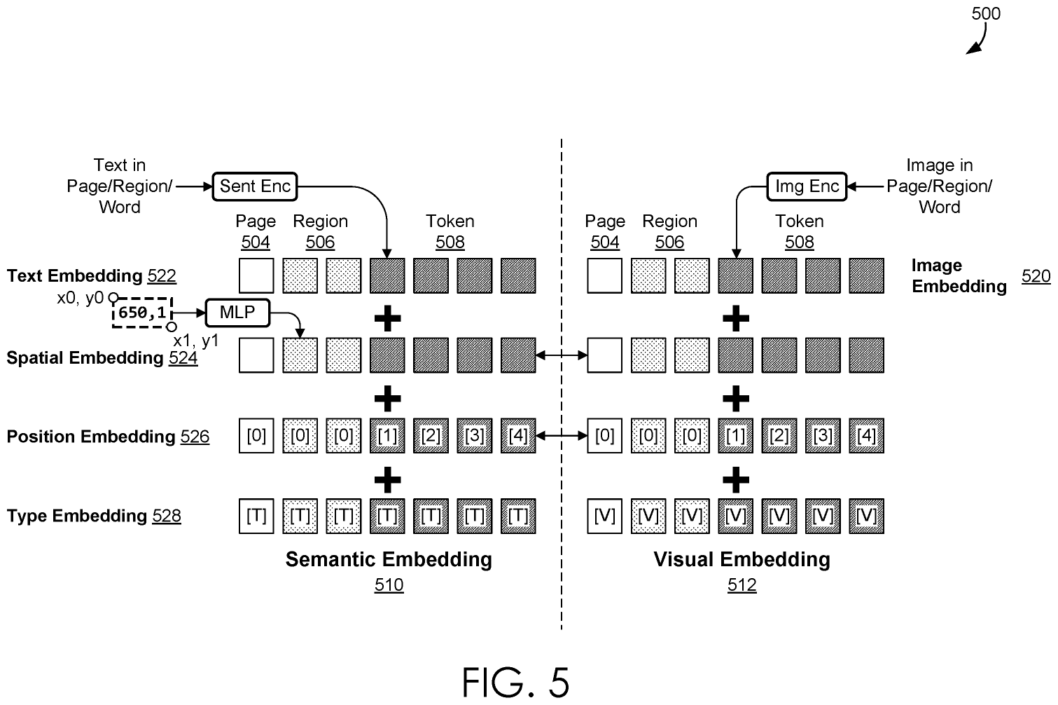

As described above, for example, the multi-modal multi-granular model receives inputs generated based on regions of multiple granularity (e.g., whole-page, paragraphs, tables, lists, form components, images, words, and/or tokens). In addition, in various embodiments, the multimodal multi-granular model represents alignments between regions that interact spatially through a self-attention alignment bias and learns multi-granular alignment through an alignment loss function. In various embodiments, the multi-modal multi-granular model includes multi-granular input embeddings (e.g., input embedding across multiple granularities generated by the input generator as illustrated in FIG. 5), cross-granular attention bias terms, and multi-granular region alignment for self-supervised training that causes the multi-modal multi-granular model to learn to incorporate information from regions at multiple granularities (e.g., determine relationships between regions).

In various embodiments, document extraction is performed, by at least analyzing regions of different sizes within the document. Furthermore, by analyzing regions of different sizes within the document, the multi-modal multi-granular model, for example, can be used to perform relation extraction (e.g., parent-child relationships in forms, key-value relationships in semi-structured documents like invoices and forms), entity recognition (e.g., detecting paragraphs for decomposition), and/or sequence labeling (e.g., extracting dates in contracts) by at least analyzing regions of various sizes including an entire page as well as individual words and characters. In some examples, document classification analyzes the whole page, relation extraction and entity recognition analyze regions of various sizes, and sequence labeling analyzes individual words.

The multi-modal multi-granular model, advantageously, generates data that can be used to perform multiple distinct tasks (e.g., entity recognition, document classification, etc.) at multiple granularities which reduces model storage cost and maintenance as well as improves performance over conventional systems as a result of the model obtaining information from regions at different granularities. In one example, the multi-modal multi-granular model obtains information from a table of itemized costs (e.g., coarse granularity) when looking for a total value (e.g., fine granularity) in an invoice or receipt. In other examples, tasks require data from multiple granularities—such as determining parent child relationships in a document (e.g., checkboxes in a multi-choice checkbox group in a form) which requires looking at the parent region and child region at different granularities. As described in greater detail below in connection with FIG. 5, including these different regions in the input embedding layer advantageously enables the multi-modal multi-granular model to extract or otherwise obtain information from different granularities.

Advantageously, the multi-modal multi-granular model provides a single model that, when used with other models, provides optimal results for a plurality of tasks thereby reducing training and maintenance costs required for the models to perform these tasks separately. To put in other words, the multi-modal multi-granular model provides a single model that generates an optimized input to other models to perform tasks associated with the document thereby reducing the need to maintain multiple models. Furthermore, the multi-modal multi-granular model is also capable of detecting and/or obtaining context information or other information across regions and/or levels of the document. This context information or other information across regions and/or levels of the document is generally unavailable to conventional models that take as an input features extracted from a single granularity.

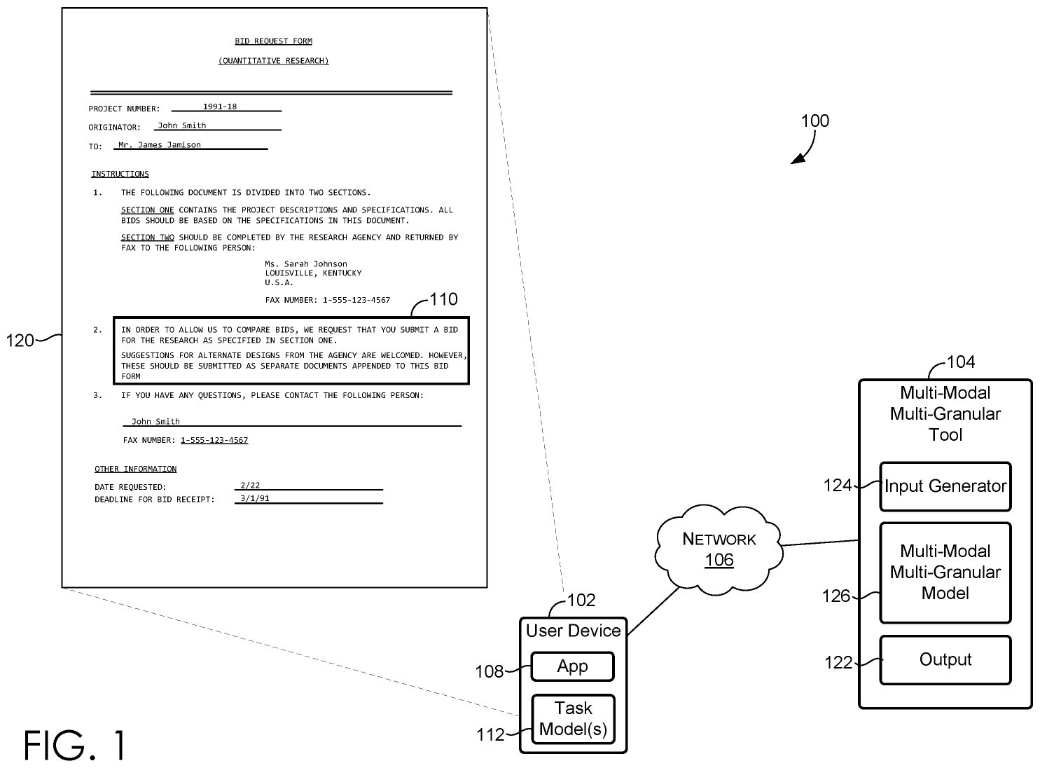

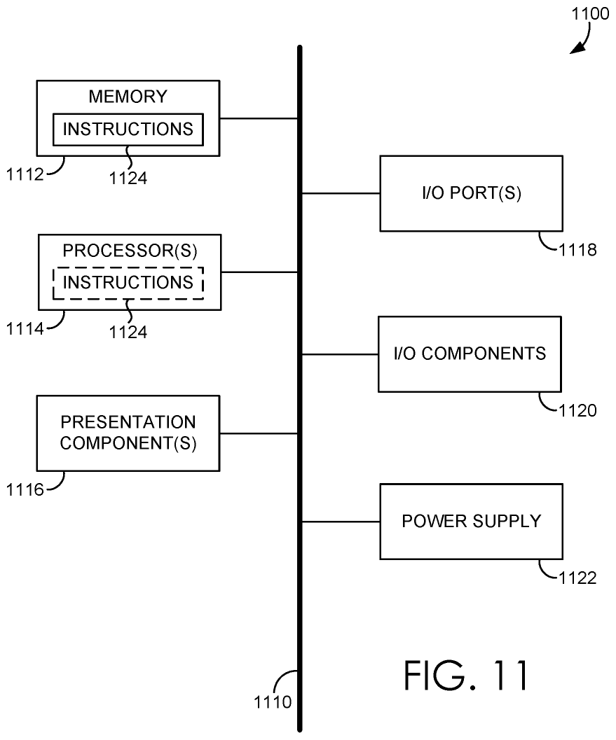

Turning to FIG. 1, FIG. 1 is a diagram of an environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 11.

It should be understood that operating environment 100 shown in FIG. 1 is an example of one suitable operating environment. Among other components not shown, operating environment 100 includes a user device 102, a multi-modal multi-granular tool 104, and a network 106. Each of the components shown in FIG. 1 may be implemented via any type of computing device, such as one or more of computing device 1100 described in connection to FIG. 11, for example. These components may communicate with each other via network 106, which may be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 106 is not described in significant detail.

It should be understood that any number of devices, servers, and other components may be employed within operating environment 100 within the scope of the present disclosure. Each may comprise a single device or multiple devices cooperating in a distributed environment.

User device 102 can be any type of computing device capable of being operated by an entity (e.g., individual or organization) associated with a document 120 from which information is to be extracted and/or one or more tasks are to be performed (e.g., entity recognition, document classification, sequence labeling, etc.). The user device 102, in various embodiments, has access to or otherwise maintains documents (e.g., the document 120) from which information is to be extracted. In some implementations, user device 102 is the type of computing device described in relation to FIG. 11. By way of example and not limitation, a user device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 108 shown in FIG. 1. Application 108 is referred to as a single application for simplicity, but its functionality can be embodied by one or more applications in practice.

The application(s) may generally be any application capable of facilitating the exchange of information between the user device 102 and the multi-modal multi-granular tool 104 in carrying out one or more tasks that include information extracted from the document 120. In some implementations, the application(s) comprises a web application, which can run in a web browser, and could be hosted at least partially on the server-side of environment 100. In addition, or instead, the application(s) can comprise a dedicated application, such as an application being supported by the user device 102 and the multi-modal multi-granular tool 104. In some cases, the application is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

In accordance with embodiments herein, the application 108 facilitates the generation of an output 122 of a multi-modal multi-granular model 126 that can be used to perform various tasks associated with the document 120. For example, user device 102 may provide the document 120 and indicate one or more tasks to be performed by a second machine learning model based on the document 120. In various embodiments, the second machine learning model includes various classifiers as described in greater detail below. Although, in some embodiments, a user device 102 may provide the document 120, embodiments described herein are not limited hereto. For example, in some cases, an indication of various tasks that can be performed on the document 120 may be provided via the user device 102 and, in such cases, the multi-modal multi-granular tool 104 may obtain such the document 120 from another data source (e.g., a data store).

The multi-modal multi-granular tool 104 is generally configured to generate the output 122 which can be used by one or more task models 112, as described in greater detail below, to perform various tasks associated with the document 120. For example, as illustrated in FIG. 1, the document 120 includes a region 110 for which as task is to be performed and/or information is to be extracted as indicated by the user through the application 108 and/or the one or more task models 112 executed by the used device 102. At a high level, to perform the various tasks, the multi-modal multi-granular tool 104 includes an input generator 124, the multi-modal multi-granular model 126, and an output 122. The input generator 124 may be or include an input embedding layer as described in greater detail below, for example, in connection with FIG. 5. In various examples, the input generator 124 may obtain textual and/or image features and corresponding bounding boxes extracted from the document 120. In such examples, the input generator 124 generates input feature vectors that encode features and/or other information obtained from the document 120. In various embodiments, the input generator 124 extracts information (e.g., the features and candidate bounding boxes) from the document 120. In yet other embodiments, one or more other machines learning models (e.g., OCR, CNN, etc.) are used to extract information from the document 120 and provide to the input generator 124 to generate an input for the multi-modal multi-granular model 126. Furthermore, the input generator 124, in an embodiment, generates the input based at least in part on information extracted from the document 120 at a plurality of granularities. For example, the input generated by the input generator 124 includes features extracted from a page-level, region-level, and word-level of the document 120.

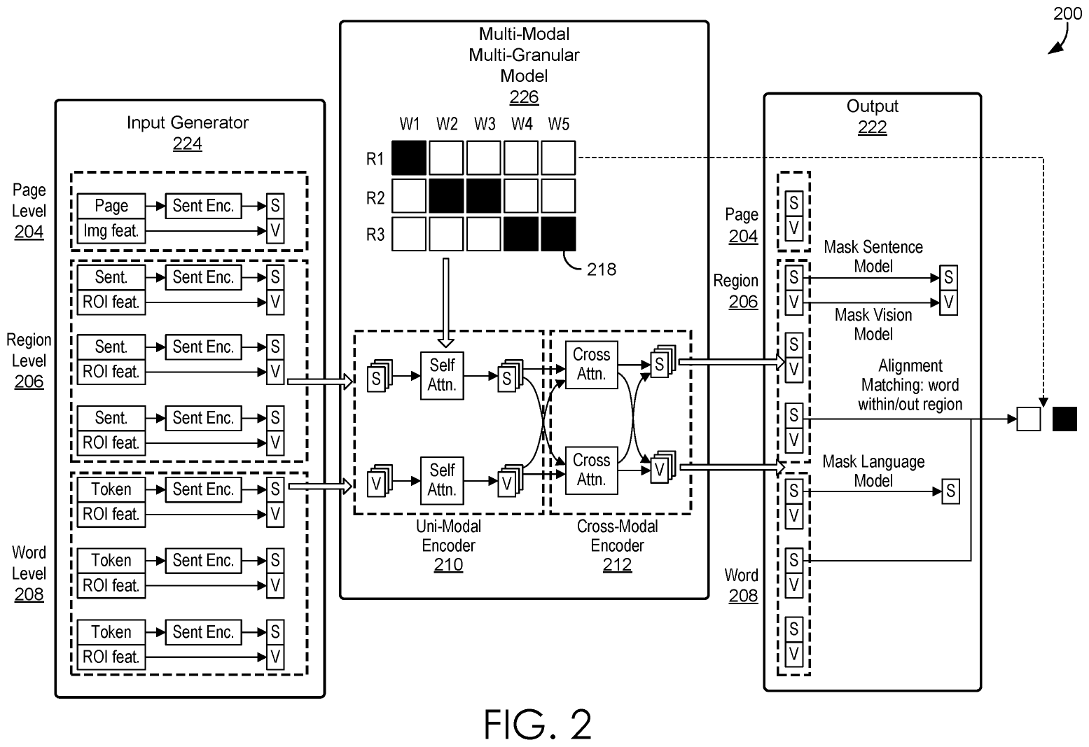

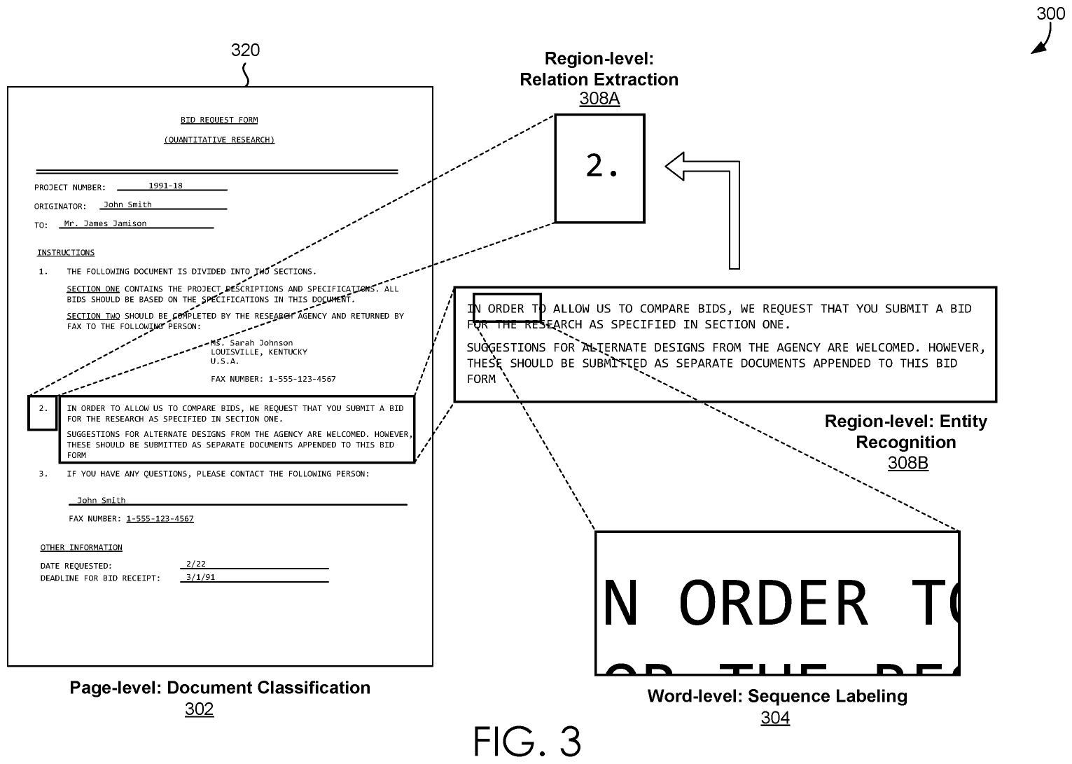

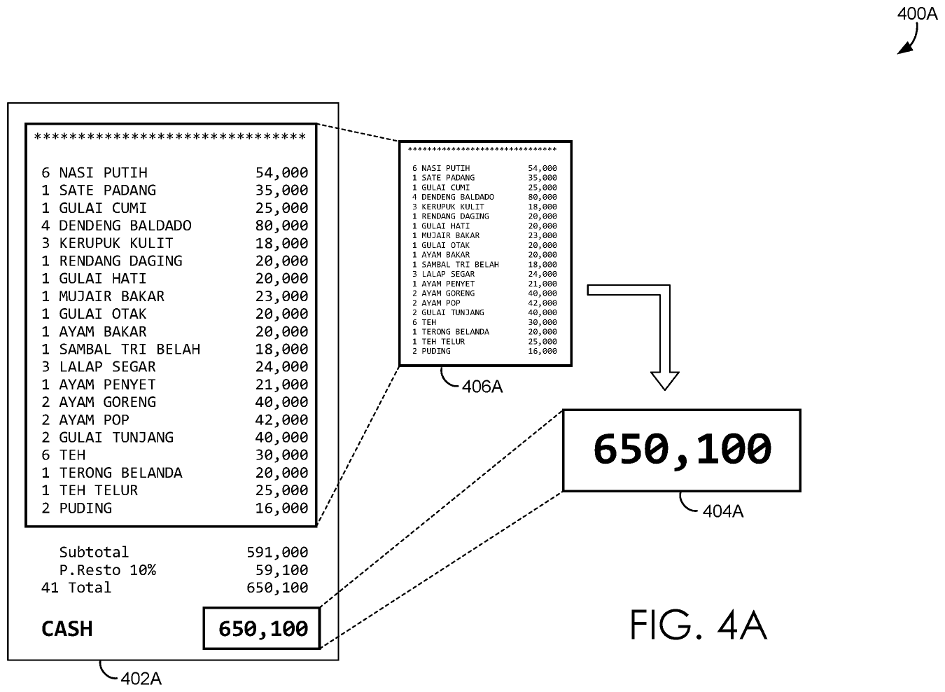

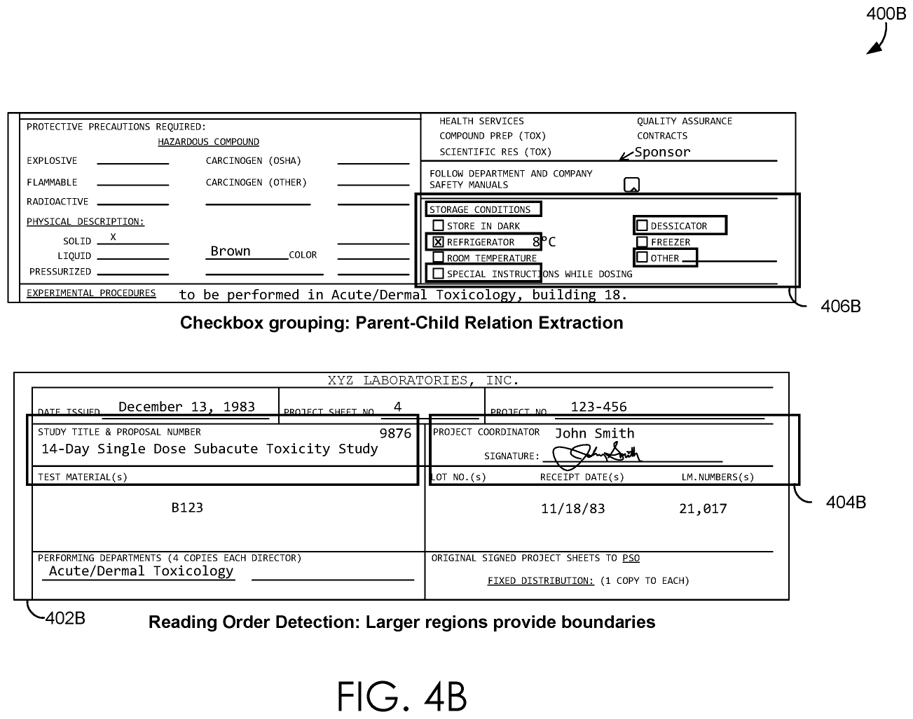

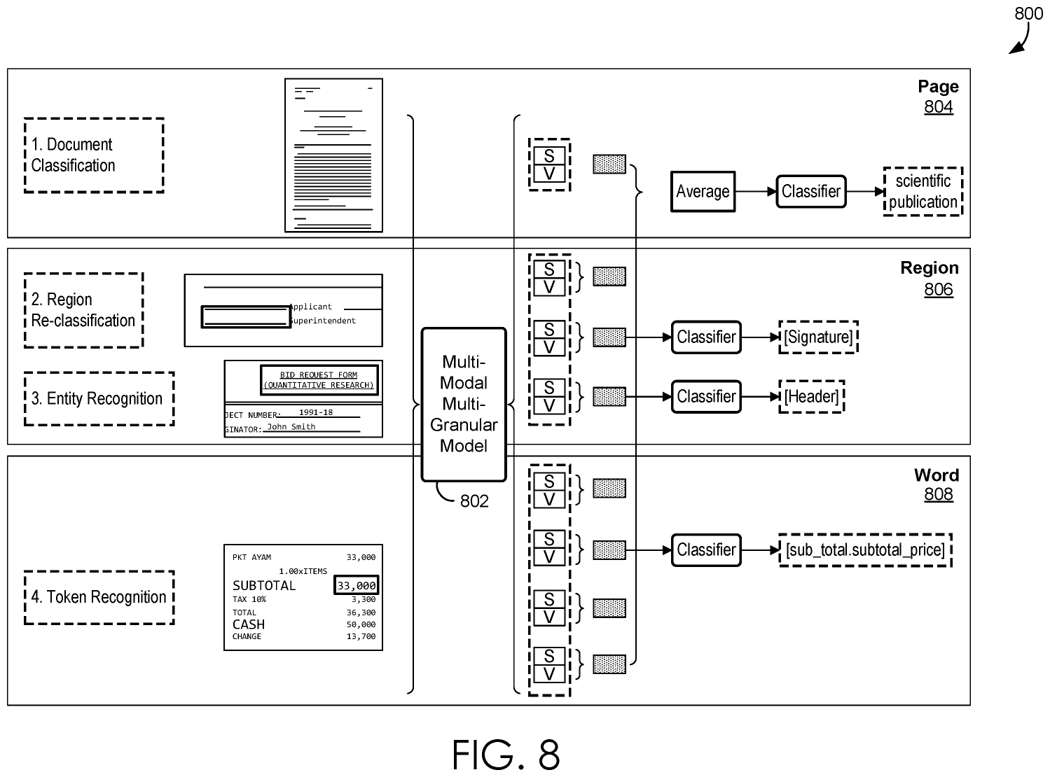

In various embodiments, the input generator 124 provide the generated input to the multi-modal multi-granular model 126 and, based on the generated input, the multi-modal multi-granular model 126 generates the output 122. As described in greater detail in connection with FIG. 2, in some embodiments, the multi-modal multi-granular model 126 includes a uni-modal encoder and a cross-modal encoder to transform the input (e.g., feature vector) based on a set of self-attention weights and cross-attention weights. In an embodiment, the output 122 is a feature vector (e.g., containing values from the input feature vectors transformed/encoded by the multi-model multi-granular model 126) that is useable by the one or more task models 112 to perform various task associated with the document 120. In various examples, the various tasks may include the task described below in connection with FIGS. 3, 4A, and 4B. In various embodiments, the multi-model multi-granular model 104 transmits the output 122 over the network 106 to the user device 102 for use by the one or more task models 112. For example, as illustrated in FIG. 8, the output 122 is used by as an input to various classifiers (e.g., one or more task models 112) to perform one or more tasks. Furthermore, although the one or more task models 112, as illustrated in FIG. 1, are executed by the user device 102, in various embodiments, all or a portion of the one or more task models 112 are executed by other entities such as a cloud service provider, a server computer system, and/or the multi-model multi-granular tool 104.

For cloud-based implementations, the application 108 may be utilized to interface with the functionality implemented by the multi-modal multi-granular tool 104. In some cases, the components, or portion thereof, of multi-modal multi-granular tool 104 may be implemented on the user device 102 or other systems or devices. Thus, it should be appreciated that the multi-modal multi-granular tool 104 may be provided via multiple devices arranged in a distributed environment that collectively provide the functionality described herein. Additionally, other components not shown may also be included within the distributed environment.

Turning to FIG. 2, FIG. 2 is a diagram of an environment 200 in which a multi-modal multi-granular model 226 is trained and/or used to generate output feature vectors and/or other information that can be used to perform various tasks associated with a document in accordance with at least one embodiment. In various embodiments, an input generator 224 obtains data from a plurality of regions of a document. In the example illustrated in FIG. 2, the input generator 224 includes data obtained from a page level 204, region level 206, and a word level 208. In an embodiment, the input generator 224, and other components described in connection with FIG. 2, includes source code or other executable code that, as a result of being executed by one or more processors of a computing device, cause the computing device to execute the operations described in the present disclosure. In various embodiments, the input generator 224 includes an input embedding layer associated with the multi-modal multi-granular model 226. For example, the input embedding layer include executable code or other logic that, as a result of being executed by one or more processors, causes the one or more processors to generate an input (e.g., fixed length feature vectors) to the multi-modal multi-granular model 226 such as described in greater detail below in connection with FIG. 5.

In various embodiments, bounding boxes, features, and other information are extracted from a document and provided to the input generator 224, which generates two input feature vectors (e.g., fixed-length feature vectors), a first feature vector corresponding to textual contents of the document (illustrated with an “S”) and a second feature vector corresponding visual contents of the document (illustrated with a “V”). For example, at the page level 204, region level 206, and/or word level 208, data from the document (e.g., a page of the document) is extracted and the textual content is provided to a sentence encoder to generate the corresponding semantic feature vector for the particular granularity from which the data was extracted. Furthermore, in such an example, a CNN or other model generates a visual feature vector based at least in part on data extracted from the particular granularity. In various embodiments, the same models and/or encoders are used to generate input feature vectors for the page level 204, the regions level 206, and the word level 208. In other embodiments, different models and/or encoders can be used for one or more granularities (e.g., the page level 204, the regions level 206, and the word level 208). Furthermore, the data extracted from the document, in an embodiment, is modified by the input generator 224 during generation of the semantic feature vector (“S”) and the visual feature vector (“V”). In one example, a CNN suggests bounding boxes that are discarded by the input generator 224. In another example, as described in greater detail below in connection with FIG. 5, the input generator 224 includes additional information such as position and type information in the semantic feature vector and visual feature vector.

In an embodiment, the textual contents and bounding boxes of regions and tokens (e.g., words) of the document are obtained from one or more other applications. In addition, in various examples, regions refer to larger areas in the page which contain several words. Furthermore, the bounding boxes, in an embodiment, include rectangles enclosing an area of the document (e.g., surrounding a token, region, word, character, page, etc.) represented by coordinates values for the left-top and bottom-right of the bounding box. In such embodiments, these coordinates are normalized with the height and width of the page and rounded to an integer value. In some embodiments (e.g., where memory may be limited), a sliding window is used to select tokens, such that the tokens are in a cluster and can provide contextual information.

Once the input generator 224 has generated the input feature vectors, in various embodiments, the feature vectors are provided to a uni-modal encoder 210 and transformed, encoded, or otherwise modified to generate output feature vectors. In one example, self-attention weights are calculated for the input feature vectors based on features within a single modality. In an example, the self-attention weights include a value that represents an amount of influence features within a single modality have on other features (e.g., influence when processed by one or more task models). In various embodiments, the self-attention is calculated based on the following formula:

$$SelfAttention ( X ) = softmax ( \frac{X {X}^{T}}{\sqrt{d}} + A + R ) X$$

where X represents the features of a single modality (e.g., semantic or visual features), A represents an alignment bias matrix 218, and R represents a relative distance bias matrix containing values calculated based at least in part on the distance between the bounding box of the features. In an embodiment, the alignment bias matrix 218 provides an indication that a particular word, token, and/or features is within a particular region (e.g., page, region, sentence, paragraph, word, etc.). In the example illustrated in FIG. 2, the alignment bias matrix 218 for column “W1” (which could represent a word, token, etc.) is within region “R1” (which represents a page, region, paragraph, etc.) as represented by a black square. Furthermore, the alignment bias matrix 218 for column “W1” is not within region “R2” represented by a white square. In various embodiments, the alignment bias matrix 218 is populated with values (e.g., one if the token is within the region and zero if the token is not within the region). For example, if a particular word “W1” in a document is within a particular region “R1,” the value within the matrix (e.g., the column corresponding to “W1” and the row corresponding to “R1”) is set of one.

Although the relationship between the token (e.g., “W1”) and the region (e.g., “R1”) is described as within in connection with FIG. 2, any number of relationships can be represented by the alignment bias matrix 218, such as above, below, next, across, left of, right of, or any other relationship between a token and a region. In various embodiments, the multi-modal multi-granular model determines this relationship (e.g., within, next to, below, etc.) based on coordinates associated with the bounding boxes corresponding to the token and/or region. In one example, the alignment bias matrix 218 is computed by at least determining whether the bounding box corresponding to a feature is within a region and assigning the appropriate value. In such embodiments, the alignment bias matrix 218 enables the multi-modal multi-granular model to efficiently learn by explicitly representing a particular relationship with the alignment bias matrix 218. Furthermore, in yet other embodiments, multiple relationships can be explicitly or implicitly represented by one or more alignment bias matrices.

In an embodiment, the uni-modal encoder 210 adds or otherwise combines the self-attention weights, the alignment bias matrix 218, and the relative distance between features to transform (e.g., modify the features based at least in part on values associated with the self-attention weights, alignment bias, and relative distance) the set of features (e.g., represented by “S” and “V” in FIG. 2). In an example, fixed length feature vectors “S” and “V” are provided as inputs to the uni-modal encoder 210, and the uni-modal encoder 210 outputs fixed-length feature vectors of the same size with the feature transformed through self-attention operations. In various embodiments, the uni-modal encoder 210 calculates self-attention values for within a single modality. In an example, the self-attention values are determined for the semantic feature vector based on the semantic features, and the self-attention values are determined for the visual feature vector based on the visual features.

In various embodiments, the output of the uni-modal encoder 210 is provided to a cross-modal encoder 212 which determines cross-attention values between and/or across modalities. In one example, the cross-attention values for the semantic feature vectors are determined based on visual features (e.g., values included in the visual feature vector). In various embodiments, the cross-attention values are determined based on the following equations:

$${Feat}_{S} = Cross Attention ( V , S ) = softmax ( \frac{V {S}^{s}}{\sqrt{d}} ) S ;$$

$${Feat}_{V} = CrossAttention ( S , V ) = softmax ( \frac{S {V}^{s}}{\sqrt{d}} ) V ;$$

$$Feat = [ {Feat}_{S} ; {Feat}_{V} ] ;$$

where S represents a semantic feature and V represents a visual feature, and the two features (e.g., Feat_{S} and Feat_{V}) are concatenated to generate the output feature included in the output feature vector. In an embodiment, the cross-attention values are calculated based on the dot production of multi-modal features (e.g., semantic and visual features). Furthermore, in various embodiments, the output of the cross-modal encoder 212 is a set of feature vectors (e.g., output feature vectors which are the output of the multi-modal multi-granular model 226) including transformed features, the transformed features corresponding to a granularity of the document (e.g., page, region, word, etc.). In an embodiment, the output of the cross-modal encoder 212 is provided to one or more machine learning models to perform one or more tasks as described above. For example, the semantic feature vector for the word-level granularity is provided to a machine learning model to label the features (e.g., words extracted from the document). In various embodiments, the set of input feature vectors generated by the input generator 224 and provided as an input to the uni-modal encoder 210, the uni-modal encoder 210 modifies the set of input feature vectors (e.g., modifies the values included in the feature vectors) to generate an output, the output of the uni-modal encoder 210 in provided as an input to the cross-modal encoder 212 which then modifies the output of the uni-modal encoder 210 (e.g., the set of feature vectors) to generate an output (e.g., the output set of feature vectors).

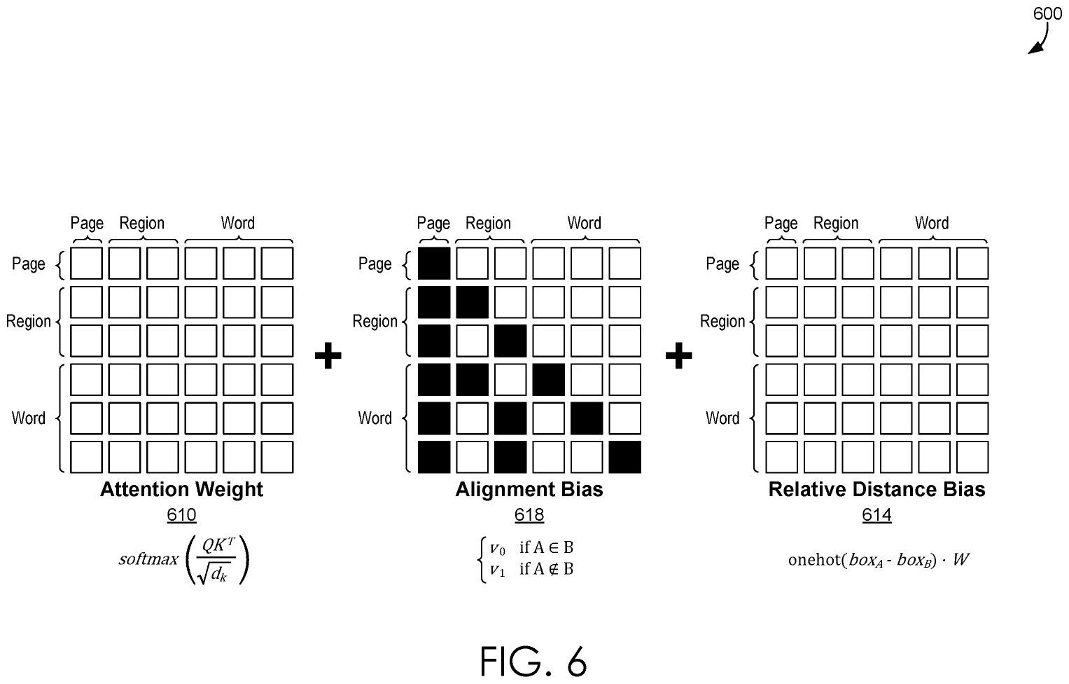

In various embodiments, during a pre-training phase, various pre-training operations are performed using the output 222 of the multi-model multi-granular model or components thereof (e.g., cross-modal encoder 212). In one example, a masked sentence model (MSM), masked vision model (MVM), and/or a masked language model (MLM) are used to perform pre-training operations. In addition, the pre-training operations, in various embodiments, include a multi-granular alignment model (MAM) to train the multi-model multi-granular model to use the alignment information (e.g., the alignment bias matrix 218) based on a loss function. For example, an alignment loss function can be used to penalize the multi-model multi-granular model and reinforce the multi-model multi-granular model use of the alignment relation. In various embodiments, as described in greater detail below in connection with FIG. 6, the dot product between regions and tokens is calculated and a binary classification is used to predict alignment.

In regards to FIGS. 2 and 5, the three granularity levels (e.g., page, region, and word) are used for illustrative purposes and any number of additional granularity levels can be used (e.g., document, sub-word, character, sentence, etc.) and/or one or more granularity levels can be omitted.

Turning to FIG. 3, FIG. 3 is a diagram of an example 300 in which one or more embodiments of the present disclosure can be practiced. The example 300 shown in FIG. 3 is an example of results generated by one or more task models (e.g., a second machine learning model) based on outputs generated by a multi-model multi-granular model. In various embodiments, FIG. 3 includes a document 320 comprising a plurality of granularity levels (e.g., region sizes of the document 320), such as a page-level 302, a plurality of region-levels 308A and 308B, and a word-level 304. In various embodiments, the document 320 can include additional granularity levels not illustrated in FIG. 3 for simplicity. For example, the document 320 can include a plurality of pages including a plurality of regions and tokens in various layouts. Furthermore, the document 320, in an embodiment, is displayed, stored, maintained, or otherwise processed by a computing device such as one or more of computing device 1100 described in connection to FIG. 11. In an example, a computing device obtains the document 320 and performs one or more tasks on the document (e.g., document classification, relation extraction, entity recognition, sequence labeling, etc.) using at least in part a multi-modal multi-granular model.

Furthermore, a computing device, in various embodiments, communicates with other computing devices via a network (not shown in FIG. 3 for simplicity), which may be wired, wireless, or both. For example, a computing device executing a multi-modal multi-granular model may obtain the document 320 from another computing device over a network.

In various embodiments, a multi-modal multi-granular model generates and/or extracts data from the document 320 at one or more regions (e.g., granularities) of the document 320. In one example, the multi-modal multi-granular model generates a set of feature vectors used by one or more task machine learning models to perform document classification based on data obtained from the document 320 at a plurality of granularity levels (e.g., the page-level 302 granularity). As described in greater detail below in connection with FIG. 5, the multi-modal multi-granular model obtains as an input a set of feature vectors corresponding to the plurality of granularities, generated based on the document 320, and outputs a set of modified feature vectors which can then be provided to a task-specific model.

In an embodiment, an OCR model, CNN, and/or other machine learning model generates a set of input feature vectors based at least in part on the document 320, the set of input feature vectors are processed by the multi-modal multi-granular model and then provided, as set of output feature vectors (e.g., the result of the multi-modal multi-granular model processing the set of input feature vectors) to a document classification model to perform the document classification task. Similarly, when performing relation extraction tasks, the multi-modal multi-granular model generates a modified set of feature vectors (e.g., the set of output feature vectors) which are then used by one or more additional task models to extract relationships between regions and/or other granularities (e.g., words, pages, etc.). In the example illustrated in FIG. 3, the character “2” corresponding to region 308A is related to the paragraph corresponding to region 308B, and the multi-modal multi-granular model can be used to extract this relationship based at least in part on inputs from a plurality of granularities and/or regions. For example, as described in greater detail below in connection with FIG. 3, the multi-modal multi-granular model transform the input (e.g., a set of feature vectors) to include self-attention weights (e.g., within a single modality) and cross-attention weights (e.g., between modalities) that can represent the relationships between the plurality of granularities and/or regions.

FIGS. 4A and 4B illustrate examples 400A and 400B in which a multi-modal multi-granular model is used at least in part to extract a relationship between regions of a document within at least one embodiment. In the example 400A of FIG. 4A, a document 402A includes a table 406A and a total 404A. For example, the document 402A includes a receipt, invoice, or other structured, semi-structured, or un-structured document. In various embodiments, the multi-modal multi-granular model encodes a relationship between the table 406A and the total 404A in one or more output feature vectors. In the example illustrated in FIG. 4A, a bounding box associated the table 406A and features extracted from the table 406A provide information (e.g., as a result of being processed by the multi-modal multi-granular model) that can be used to classify the number within a bounding box associated with the total 404A. In an example, the bounding box associated the table 406A is at a first granularity (e.g., medium or region level) and the bounding box associated with the total 404A is at a second granularity (e.g., fine or token level).

Turning to FIG. 4B, the example 400B, in various embodiments, the document 402B includes a form containing various checkboxes, boundary lines, fillable lines, and other elements. For example, the document 402B can include a checkbox grouping 406B and a signature box 404B. In various embodiments, for the checkbox grouping 406B, determining which group a set of fields belongs to requires analyzing the checkbox grouping 406B (e.g., medium granularity) and fields within the checkbox grouping 406B (e.g., fine granularity). In such embodiments, the multi-modal multi-granular model takes as an input information (e.g., bounding boxes and features) from the plurality of granularities in order to determine relationships within the checkbox grouping 406B (e.g., child-parent relationship, inside relationship, next-to relationship, etc.). Similarly, for other tasks such as reading order, in various embodiments, the multi-modal multi-granular model analyzes data from regions (e.g., medium granularity) to determine boundaries informing which words (e.g., fine granularity) follows another. In yet another example, classifying the entire document 402B and/or 402A can be performed based at least in part on data from granularities other than the page-level (e.g., the word-level total for price and/or the region-level table of items combined with word-level total for price).

Turning now to FIG. 5, FIG. 5 is a diagram of an example 500 in which inputs for a multi-modal multi-granular model are generated in accordance with at least one embodiment. In various embodiments, features are extracted from a page-level 504, region-level 506, and token-level 508 of a document. As described above, in various examples, the page-level 504, region-level 506, and token-level 508 correspond to different granularities of the document. In various embodiments, the inputs to the multi-modal multi-granular model include a semantic embedding 510 and a visual embedding 512. In an example, the semantic embedding 510 and the visual embedding 512 include a fixed-dimension feature vector that includes information extracted from the document such as feature embedding (e.g., text embedding 522 or image embedding 520), spatial embedding 524, position embedding 526, and type embedding 528.

Furthermore, in the example illustrated in FIG. 5, text from the various granularities is extracted from the document and processed by a sentence encoder or other model to generate semantic features (e.g., encode text into one or more vectors) included in the text embedding 522. In one example, an OCR application extracts characters, words, and/or sub-words from the document and provides candidate regions and/or bounding boxes. In various embodiments, the textual content of a particular granularity is provided to the sentence encoder and a vector is obtained. For example, the text within a particular region of the document is provided to the sentence encoder and a vector representation of the text is obtained for the text embedding 522. In another example, the textual contents of page, regions, and/or tokens are provided as an input to a Sentence BERT (SBERT) algorithm and the hidden states of the sub-tokens are averaged as the encoded text embedding 522.

As illustrated in FIG. 5 as squares with various type of shading representing a particular granularity, a vector representation is obtained representing the features (e.g., semantic embedding 510 or visual embedding 512) for the various granularities (e.g., page-level 504, region-level 506, and token-level 508) to which the spatial embedding 524, the position embedding 526, and the type embedding 528 are added to generate a vector used as an input to the multi-modal multi-granular model. In other embodiments, these vectors are stacked to form a matrix used as an input to the multi-modal multi-granular model. In an embodiment, the spatial embedding 524 represents information indicating a location of a corresponding feature in the document. In one example, the coordinates of bounding boxes are projected to hyperspace with multi-layered perceptron (MLP), and the spatial embedding 524 of the same dimension is acquired. In such examples, the spatial embedding 524 is of the same dimension as the text embedding 522.

In various embodiments, the position embedding 526 includes information indicating the position of the feature relative to other features in the document. In one example, features are assigned a position value (e.g., 0, 1, 2, 3, 4, . . . as illustrated in FIG. 5) based on a position index starting in the upper left of the document. In various embodiments, the position index is sequential to provide context information associated with the features and/or document. In an example, the position embedding 526 information indicates an order of features within the document. The type embedding 528, in various embodiments, includes a value indicating the type of features. For example, the type embedding 528 contains a first value to indicate a semantic feature of the document and a second value to indicate a visual feature of the document. In various embodiments, the type embedding 528 includes alphanumeric values.

In addition, in the example illustrated in FIG. 5, image information is extracted from the document and processed by an image encoder or other model to generate visual features to include (e.g., embed) in the image embedding 520. In an example, a page of the document is processed by a CNN, and image features and regions are extracted. In another example, a page of the document is processed by a Sentence-BERT network and text features and regions are extracted. In various embodiments, the semantic embedding 510 and visual embedding 512 include a vector where the feature embedding (e.g., text embedding 522, image embedding 520, or other features extracted from the document) are added to the spatial embedding 524, the position embedding 526, and the type embedding 528. In yet other embodiments, the spatial embedding 524, the position embedding 526, and the type embedding 528 are maintained in separate rows to form a matrix.

FIG. 6 is a diagram of an example 600 in which self-attention weights incorporate alignment bias and relative distance bias for a multi-modal multi-granular model in accordance with at least one embodiment. As described above in connection with FIG. 2, the input (e.g., feature vector) is provide to a uni-modal encoder which determines a set of attention weights 610 corresponding to the input. In various embodiments, an alignment bias 618 is added to the set of attention weights 610. In one example, the alignment bias 618 is cross-granularity such that relationships between granularities are accounted for by the multi-modal multi-granular model. One example relationship includes a smaller region within a larger region.

In an embodiment, the alignment bias 618 is represented as a matrix where a first set of dimensions (e.g., rows or columns) represent portions and/or regions of the document across granularities (e.g., page, region, words) and a second set of dimensions represent features (e.g., tokens, words, image features etc.). In such embodiments, the value V₀ is assigned to a position in the matrix if the feature A corresponding to the position is an ∈ region B corresponding to the position. Furthermore, in such embodiments, the value V₁ is assigned to a position in the matrix if the feature A corresponding to the position is an ∉ region B corresponding to the position.

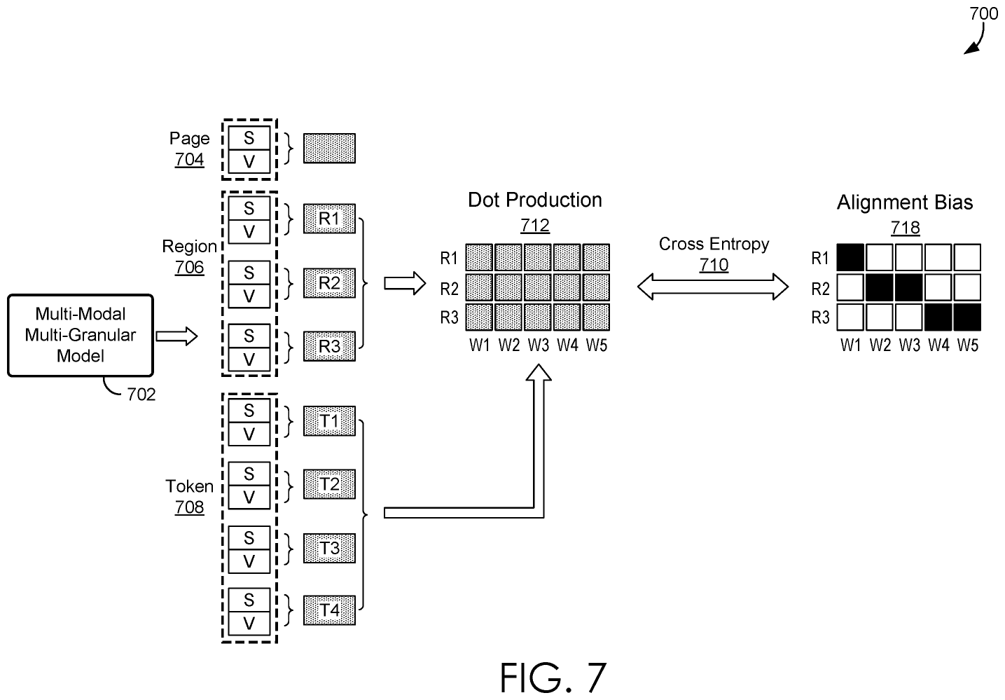

In various embodiments, during transformation of the input using attention-weights alignment bias 618 enables the multi-modal multi-granular model to encode relationships between features and/or regions. In addition, as described below in connection with FIG. 7, an alignment loss function based at least in part on the alignment bias 618 enables the multi-modal multi-granular model to determine the correct weight to attribute to relationships between features and/or regions. In an embodiment, the uni-modal encoder for the plurality of modalities (e.g., semantic and visual) provides a single modality to multi-layered self-attention (e.g., six layers) to generate contextual representation. Furthermore, as in the example illustrated in FIG. 6, two spatial loss terms for are added, alignment bias 618 and relative distance bias 614, as illustrated by the following equation:

$$SelfAttention ( X ) = softmax ( \frac{X {X}^{t}}{\sqrt{d}} + A + R ) X$$

where A represents the alignment bias 618 and R represents the relative distance bias 614. In one example, to generate the alignment bias 618 the bounding boxes corresponding to regions are compared to bounding boxes corresponding to features to determine if a relationship (e.g., ∈) is satisfied. In various embodiments, if the relationship is satisfied (e.g., the word X is in the region Y), a value is added to the corresponding attention weight between the region and the feature. In such embodiments, the value added to the attention weight is determined such that the multi-modal multi-granular model can be trained based at least in part on the relationship.

In an embodiment, the relative distance bias 614 represents the distance between regions and features. In one example, relative distance bias 614 is calculated based at least in part on the distance between bounding boxes (e.g., calculated based at least in part on the coordinates of the bounding boxes). In various embodiments, the relative distance bias 614 (e.g., the value calculated as the distance between bounding boxes) is added to the attention weights 610 to strengthen the spatial expression. For example, attention weights 610 (including the alignment bias 618 and the relative distance bias 614) indicates to the multi-modal multi-granular model how much attention features should assign to other features (e.g., based at least in part on feature type, relationship, location, etc.). In various embodiments, the multi-modal multi-granular model includes a plurality of alignment biases representing various distinct relationships (e.g., inside, outside, above, below, right, left, etc.). In addition, in such embodiments, the plurality of alignment biases can be included in separate instances of the multi-modal multi-granular model executed in serial or in parallel.

FIG. 7 is a diagram of an example 700 in which a set of pre-training tasks are executed by a multi-modal multi-granular model 702 in accordance with at least one embodiment. In various embodiments, a training dataset is used to generate a set of inputs to the multi-modal multi-granular model. For example, semantic features (e.g., linguistic embeddings) and bounding boxes indicating regions of a set of documents are extracted using OCR to create an input to the multi-modal multi-granular model 702 (e.g., such as the input described above in connection with FIG. 5). In various embodiments, a Masked Sentence Model (MSM) pre-training task includes masking textual contents of a portion (e.g., fifteen percent) of the regions in the input to the multi-modal multi-granular model 702 with a placeholder “[MASK].” In one example, these regions to be masked are selected randomly or pseudorandomly from the plurality of granularities (e.g., page 704, region 706, and token 708).

In various embodiments, documents include a plurality of regions within different granularity levels as described above. In one example, a highest granularity level includes a page 704 of the document, a medium granularity level includes a region 706 of the document (e.g., a portion of the document less than a page), and a lowest granularity level includes a token 708 within the document (e.g., a word, character, image, etc.). The pre-training MSM task includes, in various embodiments, calculating the loss (e.g., L1 loss function) between the corresponding region output features and the original textual features. In yet other embodiments, the MSM pre-training task is performed using visual features extracted from the set of documents.

In an embodiment, the pre-training tasks include a multi-granular alignment model (MAM) to train the multi-modal multi-granular model 702 to use the alignment information included in the alignment bias 718. In one example, an alignment loss function is used to reinforce the multi-modal multi-granular model 702 representation of the relationship indicated by the alignment bias 718. In an embodiment, the dot product 712 between regions and tokens included in the output (e.g., feature vector) of the multi-modal multi-granular model 702 is calculated and binary classification performed to predict alignment. In various embodiments, the loss function includes calculating the cross entropy 710 between the dot product 712 and the alignment bias 718. In the MAM pre-training task, for example, a self-supervision task is provided to the multi-modal multi-granular model 702, where the multi-modal multi-granular model 702 is rewarded for identifying relationships across granularities and penalized from not identifying relationships (e.g., as indicated in the alignment bias 718).

In various embodiments, the multi-modal multi-granular model 702 is pre-trained and initialized with weights based on a training dataset (e.g., millions of training sample documents) and then used to process additional datasets to label the data and adapt the weights specifically for a particular task. In yet other embodiments, the weights are not modified after pre-training/training. Another pre-training task, in an embodiment, includes a mask language model (MLM). In one example, the MLM masks a portion of words in the input and predicts the missing word using the semantic output features obtained from the multi-modal multi-granular model 702.

FIG. 8 is a diagram of an example 800 in which a multi-modal multi-granular model 802 generates an output that is used by one or more other models (e.g., a second machine learning model) to perform a set of tasks in accordance with at least one embodiment. In various embodiments, the multi-modal multi-granular model 802 obtains as an input a set of features extracted from a document and outputs a transformed set of features including information indicating relationships between features and/or regions as described in detail above. Furthermore, the output of the multi-modal multi-granular model 802, in various examples, is provided to other models (e.g., classifiers) to perform a particular task (e.g., token recognition). In the example illustrated in FIG. 8, the tasks include document classification, region classification/re-classification, entity recognition, and token recognition, but additional tasks can be performed using the output of the multi-modal multi-granular model 802 in accordance with the embodiments described in the present disclosure.

In an example, a model can perform an analytics task which involves classifying a page 804 into various categories to obtain statistics about a collection analysis. In another example, the analytics task includes inferring a label about the page 804, region 806, and/or word 808. Another task includes information extraction to obtain a single value. In embodiments including information extraction, multi-modal multi-granular model 802 provides a benefit by at least modeling multiple granularities enabling the model performing the tasks to use contextual information from coarser or finer levels of granularity to extract the information.

In an embodiment, the output of the multi-modal multi-granular model 802 is used by a model to perform form field grouping which involves associating widgets and labels into checkbox form fields, multiple checkbox fields into choice groups, and/or classifying choice groups as single- or multi-select. Similarly, in embodiments including form field grouping, the multi-modal multi-granular model 802 provides a benefit by including relationship information in the output. In other embodiments, the task performed includes document re-layout (e.g., reflow) where complex documents such as forms have nested hierarchical layouts. In such examples, the multi-modal multi-granular model 802 enables a model to reflow documents (or perform other layout modification/editing tasks) based at least in part on the granularity information (e.g., hierarchical grouping of all elements of a document) included in the output.

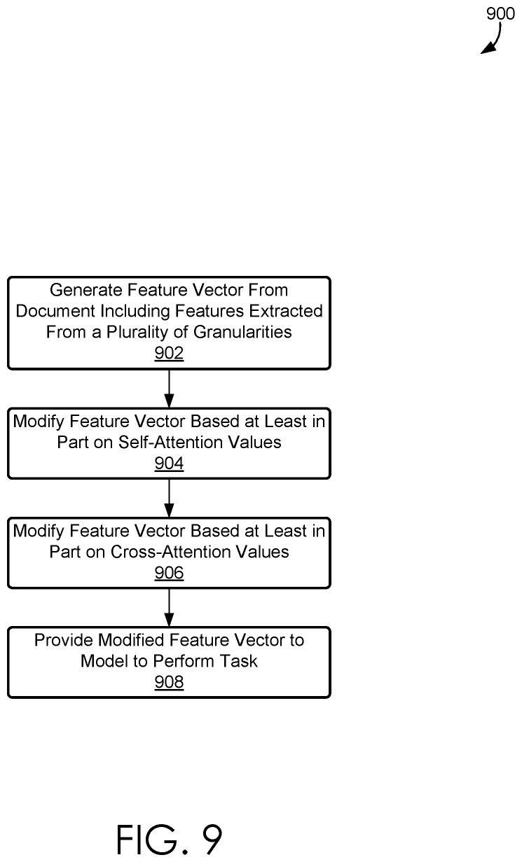

Turning now to FIG. 9, FIG. 9 provides illustrative flows of a method 900 for using a multi-modal multi-granular model to perform one or more task. Initially, at block 902, a feature vector is obtained from a document including features extracted from a plurality of granularities. For example, a machine learning model (e.g., CNN) extracts a plurality of features and bounding box information from the document. Furthermore, in various embodiments, an input embedding layer (e.g., the input generator 224 as described above in connection with FIG. 2) generates an input (e.g., feature vector) that includes features extracted from a plurality of documents, such as described in greater detail above in connection with FIG. 5. In an embodiment, the feature vector corresponding to a feature type. For example, the feature vector can include semantic features or visual features extracted from the document.

At block 904, the system executing the method 900, modifies the feature vector based on a set of self-attention values. In an example, semantic features (e.g., features included in the feature vector) extracted from the document are transformed based on attention weights calculated based at least in part on other semantic features (e.g., included in the feature vector). In various embodiments, the self-attention values are calculated using the formula described above in connection with FIG. 1.

At block 906, the system executing the method 900, modifies the feature vector based on a set of cross-attention values. In an example, semantic features (e.g., features included in the feature vector) extracted from the document are transformed based at least in part on attention weights calculated based at least in part on other features types (e.g., visual features included in a visual feature vector). In various embodiments, the cross-attention values are calculated using the formula described above in connection with FIG. 1.

At block 908, the system executing the method 900, provides modified feature vectors to a model to perform a task. For example, as described above in connection with FIG. 1, the multi-modal multi-granular model outputs a set of feature vectors (e.g., a feature vector corresponding to a type of feature vector) which can be used as an input to one or more other models.

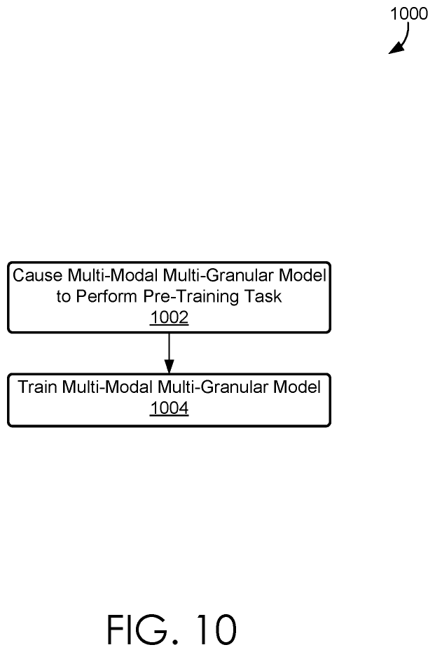

Turning now to FIG. 10, FIG. 10 provides illustrative flows of a method 1000 for training a multi-modal multi-granular model. Initially, at block 1002, the system executing the method 1000 causes the multi-modal multi-granular model to perform one or more pre-training tasks. In one example, the pre-training tasks include tasks described in greater detail above in connection with FIG. 7. In various embodiments, an pre-training tasks include using an alignment loss function to penalize the multi-model multi-granular model and reinforce the multi-model multi-granular model use of the alignment relation.

At block 1004, the system executing the method 1000, trains the multi-model multi-granular model. In various embodiments, training the multi-model multi-granular model includes providing the multi-model multi-granular model with a set of training data objects (e.g., documents) for processing. For example, the multi-model multi-granular model is provided a set of documents including features extracted at a plurality of granularities for processing.

Having described embodiments of the present invention, FIG. 11 provides an example of a computing device in which embodiments of the present invention may be employed. Computing device 1100 includes bus 1110 that directly or indirectly couples the following devices: memory 1112, one or more processors 1114, one or more presentation components 1116, input/output (I/O) ports 1118, input/output components 1120, and illustrative power supply 1122. Bus 1110 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 11 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 11 and reference to “computing device.”

Computing device 1100 typically includes a variety of computer-readable media. Computer-readable media can be any available media that can be accessed by computing device 1100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1100. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1112 includes computer storage media in the form of volatile and/or nonvolatile memory. As depicted, memory 1112 includes instructions 1124. Instructions 1124, when executed by processor(s) 1114 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 1100 includes one or more processors that read data from various entities such as memory 1112 or I/O components 1120. Presentation component(s) 1116 present data indications to a user or other device. Exemplary presentation components include a display device, speaker, printing component, vibrating component, etc.

I/O ports 1118 allow computing device 1100 to be logically coupled to other devices including I/O components 1120, some of which may be built in. Illustrative components include a microphone, joystick, game pad, satellite dish, scanner, printer, wireless device, etc. I/O components 1120 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 1100. Computing device 1100 may be equipped with depth cameras, such as stereoscopic camera systems, infrared camera systems, RGB camera systems, and combinations of these, for gesture detection and recognition. Additionally, computing device 1100 may be equipped with accelerometers or gyroscopes that enable detection of motion. The output of the accelerometers or gyroscopes may be provided to the display of computing device 1100 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. One or more non-transitory computer-readable storage media storing executable instructions that, when executed by a processing device, cause the processing device to perform operations comprising:
obtaining a set of features of a document for a plurality of granularities of the document;
modifying, via a machine learning model, the set of features of the document to generate a set of modified features using a set of self-attention values to determine relationships within a first type of feature and a set of cross-attention values to determine relationships between the first type of feature and a second type of feature; and
providing the set of modified features to a second machine learning model to perform a classification task.

2. The media of claim 1, wherein the first type of feature comprises a textual feature and the second type of feature comprises a visual feature.

3. The media of claim 2, wherein a first subset of self-attention values of the set of self-attention values are determined by calculating self-attention for the textual features.

4. The media of claim 2, wherein a first subset of cross-attention values of the set of cross-attention values are determined by calculating cross-attention between the textual features and the visual features.

5. The media of claim 1, wherein the set of self-attention values further comprise an alignment bias indicating a relationship between tokens and regions of the document.

6. The media of claim 1, wherein the set of features comprises a fixed dimension vector including feature information, spatial information, position information, type information, or a combination thereof.

7. The media of claim 1, wherein the plurality of granularities of the document include a page-level granularity, a region-level granularity, and a token-level granularity.

8. The media of claim 1, wherein the set of features comprises a fixed dimension vector.

9. A method comprising:
obtaining a first feature vector and a second feature vector, obtained from a document, including information obtain at a plurality of granularities including page-level, region-level, and token-level;
modifying, via a machine learning model, the first feature vector to generate a self-attention first feature vector with a first set of self-attention weights based on features of the first feature vector from the plurality of granularities and the second feature vector to generate a self-attention second feature vector with a second set of self-attention weights based on features of the second feature vector from the plurality of granularities;
modifying, via the machine learning model, the self-attention first feature vector to generate a cross-attention first feature vector with a first set of cross-attention weights based on the self-attention second feature vector and the self-attention second feature vector to generate a cross-attention second feature vector with a second set of cross-attention weights based on the self-attention first feature vector; and
providing at least a portion of the cross-attention first feature vector or the cross-attention second feature vector to a classifier to perform a task.

10. The method of claim 9, wherein the computer-implemented method further comprises causing a Convolutional Neural Networks (CNN) to generate the first feature vector based on a set of bounding boxes within a region of the document.

11. The method of claim 9, wherein encoding the first feature vector with the first set of self-attention weights further comprises adding an alignment bias and a relative distance bias.

12. The method of claim 11, wherein the alignment bias comprises a matrix indicating a relationship between a token included in the document and a region of the document.

13. The method of claim 12, wherein the relationship includes at least one of: inside, above, below, right of, and left of.

14. The method of claim 11, wherein the relative distance bias includes a matrix of distance values calculated based at least in part on bounding boxes associated with one or more regions of the document.

15. The method of claim 11, wherein the task comprises at least one of: document classification, region classification, entity recognition, and token recognition.

16. A system comprising one or more hardware processors and a memory component coupled to the one or more hardware processors, the one or more hardware processors to perform operations comprising:
obtaining a training dataset including a set of documents and a set of features extracted from the set of documents; and
training, using the training dataset, a multi-modal multi-granular model to generate feature vectors including information obtained from a plurality of regions of a document of the set of documents and relationships between features from distinct regions of the plurality of regions, wherein the features include a first type of feature and a second type of feature.

17. The computing system of claim 16, wherein the one or more hardware processors further perform operations comprising pre-training the multi-modal multi-granular model by at least causing the multi-modal multi-granular model to perform a self-supervision task including an alignment loss function to reinforce alignment information generated by the multi-modal multi-granular model.

18. The computing system of claim 17, wherein the alignment loss function comprises calculating the binary cross entropy loss between the alignment information generated by the multi-modal multi-granular model and an alignment label.

19. The computing system of claim 16, wherein the first type of feature comprises semantic features and the second type of feature comprises visual features.

20. The computing system of claim 16, wherein the generated feature vectors are used to perform at least one of: document classification, region re-classification, and entity recognition.
